(19) United States
(12) Patent Application Publication
(10) Pub. No.: US 2010/0152348 A1
(43) Pub. Date: Jun. 17, 2010

(54) Nanocompatibilized novel polymer blends

(76) Inventors: David Abecassis, Huntington, NY (US); Miriam Rafailovich, Plainview, NY (US)

Correspondence Address: Thomas A. O'Rourke;Bodner & O'Rourke, 425 Broadhollow Road, Melville, NY, 11747, US

(21) Appl. No.: 11/784,529

(22) Filed: Apr. 6, 2007

Related U.S. Application Data
(60) Provisional application No. 60/789,955, filed on Apr. 6, 2006.

(51) Int. Cl. C08K 5/19

(52) U.S. Cl. 524/236

(57) ABSTRACT

Compatibilized blends of two or more polymers may be formed using a quaternary amine treated organoclay. The quaternary amine treated organoclay may be a cloisite. A wide variety of polymeric blends may be formed. Such blends may include polyvinylchloride, ethylene vinyl, acetate, polymethyl methacrylate, styrene acrylonitrile copolymer, polycaprolactone, etc.

This application claims priority to U.S. Provisional Application Ser. No. 60/789,955 filed on Apr. 6, 2006.

References Cited

| | | |
|---|---|---|
| 7,138,452 | Nov. 21, 2006 | Kim, et al. |
| 6,747,096 | Jun. 8, 2004 | White, et al. |
| 7,049,353 | May 23, 2006 | Conroy, et al. |
| 7,173,092 | Feb. 6, 2007 | Gornowicz, et al. |
| 6,949,605 | Sep. 27, 2005 | Shankernarayanan, et al. |
| 6,906,127 | Jun. 14, 2005 | Liang, et al. |
| 6,887,938 | May 3, 2005 | Atkinson |
| 6,835,774 | Dec. 28, 2004 | White, et al. |
| 6,747,096 | Jun. 8, 2004 | White, et al |
| 6,649,704 | Nov. 18, 2003 | Brewer, et al. |
| 6,518,362 | Feb. 11, 2003 | Clough et al. |
| 6,486,257 | Nov. 26, 2002 | White, et al. |
| 6,432,548 | Aug. 13, 2002 | Alex et al. |
| 6,100,334 | Aug. 8, 2000 | Abdou-Sabet |
| 5,990,235 | Nov. 23, 1999 | Terano |
| 5,760,125 | Jun. 2, 1998 | Ohtomo, et al. |
| 5,641,833 | Jun. 24, 1997 | Jung, et al. |
| 5,596,040 | Jan. 21, 1997 | Miya, et al. |
| 5,409,996 | Apr. 25, 1995 | Shinohara, et al. |
| 5,391,625 | Feb. 21, 1995 | Arjunan |
| 5,357,022 | Oct. 18, 1994 | Banach, et al. |
| 5,304,593 | Apr. 19, 1994 | Nishio, et al. |
| 5,202,380 | Apr. 13, 1993 | Ilenda, et al. |
| 5,147,932 | Sep. 15, 1992 | Ilenda, et al. |
| 5,132,365 | Jul. 21, 1992 | Gallucci |
| 5,109,066 | Apr. 28, 1992 | Ilenda, et al. |
| 5,069,818 | Dec. 3, 1991 | Aycock, et al. |
| 4,690,976 | Sep. 1, 1987 | Hahnfeld |
| 4,600,741 | Jul. 15, 1986 | Aycock, et al. |

Polymers cover a wide range of physical properties in their different chemical compositions. For melt blending thermoplastics, many of these materials do not form alloys when processed simultaneously. The materials form very distinct domains microscopically, and tend to disintegrate easily under mechanical stress.

The energy barrier that keeps the domains large is interstitial energy. When this physical miscibility barrier is eliminated or reduced the polymers blend or the domains shrink to form a micro-composite material. When the domains get small enough, the blend can become a nanocomposite alloy with full polymer miscibility. One way to create blending is to use chemical similarity. The use of synthesis techniques is the thrust of most of the published patents.

This involves adding chemical groups to the respective polymers which get each others functional groups added, or by physical means such as gas or surface modified particle addition. Thus grafted maleic anhydride and block copolymers are cited in the rest of the literature as the compatibilizer.

One of the inventors has already discerned the blending of immiscible polymers in issued U.S. Pat. No. 6,339,121 using polyamine with a halide or polar solvent. Further work revealed that quaternary amine treated clays in particular compatibilize immiscible polymer blends. This use of quaternary amine treated organo-clays for this purpose the object of patent pending work by the author Miriam Rafailovich as patent pending 60/589,849 and PCT/US2005/025850.

This invention is actually series of inventions using different polymer blends using a variety of thermoplastic polymers and a common methodology. All the combinations preferably use quaternary amines to form the surface of the organo-clay. The organo-clay thus is one preferred claimed compatibilizer used to create the blends. Untreated carbon nanotubes can be substituted for the quaternary amine treated clay.
1. A material using a quaternary amine organoclay alone as a compatibilizer with the following materials in materials ranging from the result of a binary blend to blends of multiple polymers in the same material.
2. Whereas in claim 1 the polymer is polypropylene in ranges from 5-95% w/w.
3. Whereas in claim 1 the polymer is EVA (ethyl vinyl alcohol or acetate) in ranges from 5-95% w/w.
4. Whereas in claim 1 the polymer is PVC (polyvinyl chloride) in ranges from 5-95% w/w.
5. Whereas in claim 1 the polymer is polycarbonate in ranges from 5-95% w/w.
6. Whereas in claim 1 the polymer is PMMA (polymethyl methacrylate) in ranges from 5-95% w/w.
7. Whereas in claim 1 the polymer is SAN (styrene acrylonitrile) in ranges from 5-95% w/w.
8. Whereas in claim 1 the polymer is HIPS (high impact polystyrene) in ranges from 5-95% w/w.
9. Whereas in claim 1 the polymer is PP (polypropylene) in ranges from 5-95% w/w.
10. Whereas in claim 1 the polymer is PE (polyethylene) in ranges from 5-95% w/w.
11. Whereas in claim 1 the polymer is PCL (polycaprolactate) in ranges from 5-95% w/w.
12. Whereas in claim 1 the polymer is ABS (acetyl butyl styrene copolymer) in ranges from 5-95% w/w.
13. Whereas in claim 1-12 the compatibilizer is quaternary amine treated clay from 5-15% w/w.
14. Whereas in claim 1 the polymer is PS (polystyrene) in ranges from 5-95% w/w.
15. Whereas in claim 1 the polymer is polyamide in ranges from 5-95% w/w.
16. Whereas in claims 1-15 the quaternary amine treated clay is added to the melt phase of the thermopolymer blend.
17. Whereas in claims 2-15 the compatibilizer is an untreated carbon nanotube.

### BACKGROUND OF THE INVENTION

a) Field of the invention

The field of the invention is thermoplastic polymers in general and creating desirable blends from non compatible thermoplastic polymers in particular.

b) Description of the Related Art

U.S. Pat. No. 7,138,452 talks about the benefits of blending dissimilar polymers using a chemical compatibilizer and the use of clay as a barrier additive.
U.S. Pat. Nos. 6,747,096, and 6,949,605 as well as U.S. Pat. Nos. 6,835,774, 6,747,096, 6,486,257, 6,887,938 5,641,833 and 5,990,235, make use of block copolymers as compatibilizers.
U.S. Pat. No. 5,760,125 first speaks of a surface modified particulates but still relies on maleic anhydride and citric acid grafted polymers to compatibilize immiscible polymers.
The desirability of blending dissimilar polymers is restated with every issued patent; new properties unachievable by the polymer as a stand alone material. Desirable properties range from trobological properties to barrier and improved chemical resistance.
Numerous examples are those of either elastomers or thermoset polymers. Elastomers in particular are susceptible to chemical and UV attack are susceptible to eliminate their elasticity though chemical reaction.

In all cases, the quaternary organoclay micro-composite blend shows much better mechanical strength than would its un-compatibilized non quaternary amine clay or non carbon nanotube filled controls. The plastics may be capable of degrees of blending at melt temperature, but immiscibility and domain size make the material of too low quality for most applications. When quaternary amine treated clay of carbon nanotubes is added, the domain size shrinks and the material becomes a useable micro-composite.

The difference is easily measured using traditional mechanical tests for plastics and TEM microscopy viewing of the domains. All of the materials obtained from the various blends are recyclable and limited in use only to any eventual heat history of the individual polymers in the matrix.

### SUMMARY OF THE INVENTION

The invention is a multi-component polymer micro-composite obtained from blending 2 or more of the 11 polymers listed in the presence of quaternary amine treated clay or untreated carbon nanotubes. By controlling the ratios and the number of polymers included, fine adjustments of the composition can be obtained for a variety of novel fields of use. The receiving polymers are simply melted and clay is added to the melt phase using high shear mixing; preferably in a twin screw extruder.

### PREFERRED EMBODIMENTS

### One Step Manufacturing

The quaternary amine organo-clay or carbon nanotube is dispersed in the matrix resin (a: melt phase resin) at the same time using a single screw extruder, a co-rotation twin screw extruder, a counter-rotation twin screw extruder, a continuous compounder, a planetary gear extruder, etc.

### Two or Multi-Step Manufacturing

The microcomposite is prepared by using a polymer compounder such as a single screw extruder, a co-rotation twin screw extruder, a counter-rotation twin screw extruder, a continuous compounder, a planetary gear compounder, a batch compounder, etc. Then, the microcomposite is mixed with the additional polymer species and quaternary organo clay or untreated carbon nanotubes (a: polyolefin resin) to obtain the final products. One polymer plus a small amount of the organo-clay/carbon nanotube is added with each pass through the melt processing

The polymers listed can vary in a full range of molecular weights for the given polymer within the definition of ranges for that polymer.

Utility uses of the new blends include but are not limited to

1. Aerospace materials

2. Packaging materials

3. Construction materials

4. Marine and freshwater compatible uses

5. Improved wear (trobological properties)

6. Improved chemical resistance

7. Improved flame retardance

8. Improved mechanical properties.

1. A compatibilized blend of two or more polymers comprising a first polymer and one or more additional polymers comprising a first polymer and one or more additional polymers and a quaternary amine treated organoclay.

2. The compatibilized blend according to claim 1, wherein the quaternary amine treated organoclay is cloisite.

3. The blend according to claim 2 wherein the first polymer is an ethylene vinyl acetate and at least one of the other polymers is a polyvinylchloride.

4. The blend according to claim 2 wherein the first polymer is a polycarbonate and at least one of the other polymers is a polyvinylchloride.

5. The blend according to claim 2 wherein the first polymer is a polyvinylchloride and at least one of the other polymers is a polymethyl methacrylate (PMMA).

6. The blend according to claim 2 wherein the first polymer is a polycarbonate and at least one of the other polymers is a styrene acrylonitrile copolymer (SAN).

7. The blend according to claim 2 wherein the first polymer is a polycarbonate and at least one of the other polymers is a polycaprolactone (PCL).

8. The blend according to claim 2 wherein the first polymer is a polycarbonate and at least one of the other polymers is a polyethylene.

9. The blend according to claim 2 wherein the first polymer is a ethylene vinyl acetate and at least one of the other polymers is a polypropylene.

10. The blend according to claim 2 wherein the first polymer is a polyethylene and at least one of the other polymers is a polypropylene.

11. The blend according to claim 2 wherein the first polymer is a polyethylene and at least one of the other polymers is a polystyrene.

12. The blend according to claim 2 wherein the first polymer is a polyvinylchloride and at least one of the other polymers is an ABS copolymer.

13. The blend according to claim 2 wherein the first polymer is a polyvinylchloride and at least one of the other polymers is a polyethylene.

14. The blend according to claim 2 wherein the first polymer is a polyvinylchloride and at least one of the other polymers is a polystyrene.

15. The blend according to claim 2 wherein the first polymer is a polycarbonate and at least one of the other polymers is a polypropylene.

16. The blend according to claim 2 wherein the first polymer is an ethylene vinyl acetate, a polyvinylchloride, a polycarbonate, a polymethyl methacrylate, a SAN, a PCL, a polyethylene, a polypropylene, a polystyrene or an ABS copolymer and the second polymer is different from the first polymer.

17. The blend according to claim 2 wherein the first polymer is an ethylene vinyl acetate, polyvinylchloride, a polycarbonate, a polymethyl methacrylate, a SAN, a PCL, a polyethylene, a polypropylene, a polystyrene or an ABS copolymer and the second polymer is an ethylene vinyl acetate, a polyvinylchloride, a polycarbonate, a polymethyl methacrylate, a SAN, a PCL, a polyethylene, a polypropylene, a polystyrene or an ABS copolymer and said second polymer is different from the first polymer.

18. A method of forming a compatibilized blend of a first polymer and a second polymer comprising blending a first polymer with a quaternary amine treated organoclay adding a second polymer to said blend to form an alloy of said first and second polymers.

19. The method according to claim 18 wherein the first polymer is an ethylene vinyl acetate, polyvinylchloride, a polycarbonate, a polymethyl methacrylate, a SAN, a PCL, a polyethylene, a polypropylene, a polystyrene or an ABS copolymer and the second polymer is an ethylene vinyl acetate, a polyvinylchloride, a polycarbonate, a polymethyl methacrylate, a SAN, a PCL, a polyethylene, a polypropylene, a polystyrene or an ABS copolymer and said second polymer is different from the first polymer.
